(19) United States
(12) Patent Application Publication
(10) Pub. No.: US 2016/0132477 A1
(43) Pub. Date: May 12, 2016

(54) DIGITAL INTRA-PAGE BOOKMARK FOR USE WITH E-BOOKS

(71) Applicant: Kobo Inc., Toronto (CA)

(72) Inventors: Vanessa Ghosh, Toronto (CA); Benjamin Landau, Toronto (CA)

(21) Appl. No.: 14/538,551

(22) Filed: Nov. 11, 2014

(51) Int. Cl. G06F 17/24; G06F 3/0483

(52) U.S. Cl. CPC G06F 17/241; G06F 3/0483

(57) ABSTRACT

Examples described herein provide for a bookmark feature for inserting a bookmark pointer at a bookmarked text location within a page of an e-book rendered on a user interface display. Certain examples also provide an ability to shift the bookmarked text location from a first screen location to another bookmarked screen location, and to repaginate the e-book around the bookmarked text location at the bookmarked screen location.

### TECHNICAL FIELD

Examples described herein relate to a digital intra-page bookmark for use with e-books.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

E-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system that utilizes an e-reading device on which a digital bookmark is implemented for bookmarking a location within an e-book, according to an embodiment.

FIG. 2 illustrates an example of an e-reading device, for use with one or more embodiments described herein.

FIG. 3 illustrates an e-reading system in accordance with one or more embodiments.

FIG. 4 illustrates a method for implementing a digital bookmark for bookmarking a chosen location along the content of an e-book, according to an embodiment.

FIG. 5A through FIG. 5E illustrate examples for a digital bookmark feature in accordance with one or more embodiments.

FIG. 6A through FIG. 6C illustrate another implementation of a bookmark feature, in accordance with one or more embodiments.

### DETAILED DESCRIPTION

Examples described herein include an e-reading device and method of operation thereof, for providing an intra-page digital bookmark for an e-book. In some embodiments, an e-book feature is provided in which a user is enabled to position a bookmark pointer at a selected location of a desired e-book page (e.g., a sentence in the middle of a page). This selected location is saved upon closing the e-book reading session, and then recovered upon re-opening the e-book for a subsequent reading session.

In one implementation, the bookmark pointer includes a graphic indicator that identifies the selected location and/or text item which is being bookmarked. In a variation, the bookmark pointer identifies a page location that is then re-paginated to appear at, for example, a top or other prominent portion of a corresponding e-book page.

Among other distinctions, examples as described herein include an e-reading device that is programmed to provide intra-page bookmarking functionality. In one embodiment, a bookmark pointer is associated with a selected location (e.g., at a selected line or paragraph) along a particular page. In this way, the bookmark pointer can identify a portion or region of a rendered page, rather than identifying an entire page without specificity, as provided with many conventional approaches. Among other benefits, examples as described enable the user to continue reading from where they left off without needing to skim the page first in order to remember and re-locate where they ended the previous reading session.

According to certain embodiments, once the bookmark pointer is inserted, the user can drag an indicator to move a bookmarked location from an initial location within the displayed page to a second desired location. This movement may be upwards on the page, such as for example to line up the bookmark indicator with the top of the displayed text window on the screen. One embodiment provides that in response, the e-book content is re-paginated, so that the displayed page of text begins at the bookmarked location at the top of a displayed text window. If the bookmark indicator is then (or instead) dragged downwards, the e-book content is repaginated to appropriately adjust the displayed text above and below the bookmarked screen location within the displayed text window. This allows the user to re-read the adjacent lines above the bookmarked location by bringing in text from what was initially a previous page, but without turning the page backwards.

Certain examples described herein include an e-reading device that can operate to render at least a portion (e.g. one or more pages) of an e-book within a displayed text window that is provided on a display screen. A bookmark feature is provided at the user interface display for interactive use by a user. When a touch screen display is provided with the e-reading device, the user can make contact with the display screen to position the bookmark indicator or “pointer” at the bookmarked location. The bookmarked location can be provided at, for example, a word, line, or paragraph of text of an e-book on display.

According to some embodiments, a user invokes a bookmark feature such as described by various examples, then uses the bookmark feature to position a bookmark pointer at a bookmarked location for an e-book rendered on the e-reading device during an e-book reading session. When the e-book reading session is closed, a record of the bookmarked location is saved in a memory resource of the e-reading device. When the e-book is reopened, the e-reading device renders text content in a text window for the bookmarked location. In variations, the rendered text content can be adjusted such that the bookmarked location is positioned at or toward the top of the screen when the e-book is reopened.

Still further, an e-reading device can implement a bookmark feature that is adjustable to a shift mode, such that a bookmarked location can be moved up or down to a new bookmarked position. The e-reading device can be operated to adjust text content of the e-book to be above or below the new bookmarked position. The e-reading device adjusts the text content under the shift mode in response to a trigger, such as a touch and drag of a bookmark pointer (e.g., up or down). Among other benefits, the shift mode of the bookmark feature enables a user to re-read text that appears prior to a bookmarked location. In this manner, the shift mode enables a user to recall context at a point that precedes a location where the user stopped during a prior reading session. For example, the e-reading device repaginates the e-book to accommodate the adjusted content in a displayed text window.

A user may also release a bookmark pointer from a bookmarked location. For example, the user provides input to the e-reading device for cancelling a bookmark (e.g. because the user wishes to read further, either in the same e-book reading session or upon re-opening the e-book and starting anew), or reversing a mistake at a first bookmarked location by repositioning the bookmark pointer at a second bookmarked location. The user may provide input to release a bookmark by, for example, touching or otherwise selecting the bookmark pointer being displayed on the e-reading device as a “release input.”

An “e-reading device” can refer to any computing device that can display or otherwise render an e-book. By way of example, an e-reading device can include a mobile computing device on which an e-reading application is executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

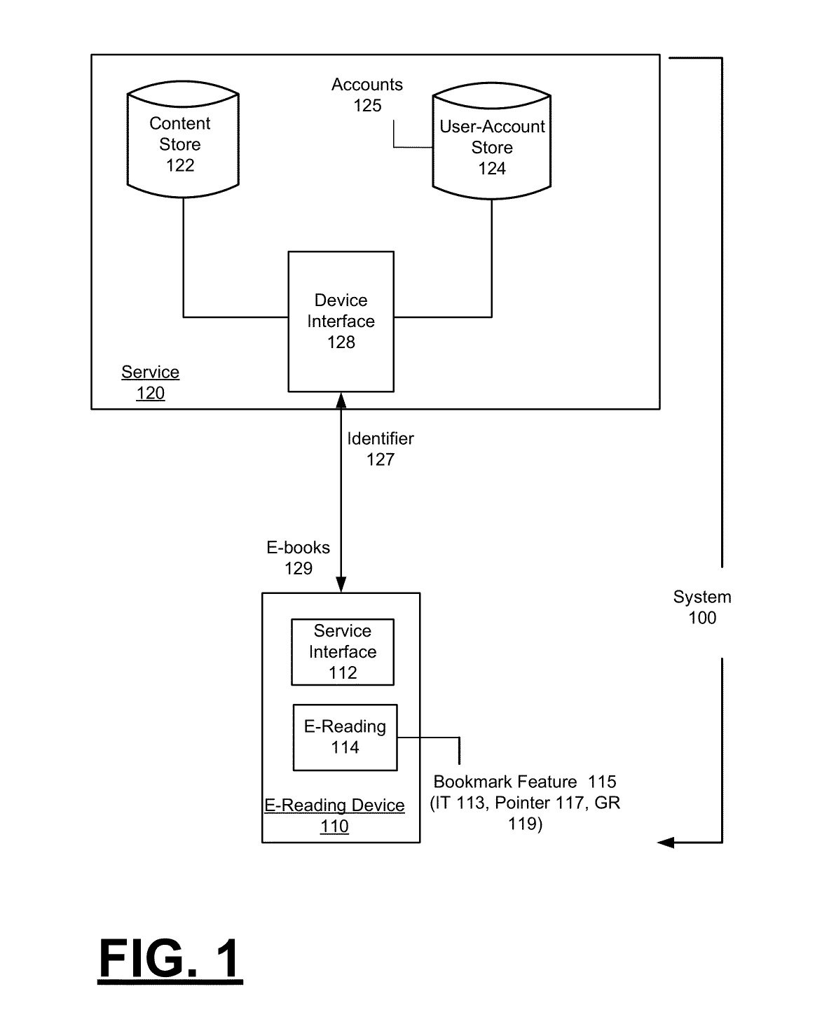

FIG. 1 illustrates a system that utilizes an e-reading device on which a digital bookmark is implemented for bookmarking a displayed portion of location within an e-book, according to an embodiment. More specifically, in an example of FIG. 1, system 100 includes an e-reading device 110 and a network service 120. Functionality for components of e-reading device 110 and service 120 as illustrated in FIG. 1 may be implemented by hardware, such as by one or more processors executing stored instructions. The network service 120 may include multiple servers and other computing resources that provide various services in connection with one or more applications that are installed on the e-reading device 110. By way of example, in one implementation, the network service 120 can provide e-book services which communicate with corresponding e-reading functionality provided on the e-reading device 110. The e-book services can enable e-books (including electronic magazines and other periodicals) to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books, including electronic magazines and other periodicals). For example, the e-reading device 110 can have a tablet like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

The e-reading device 110 can include a service interface 112 and an e-reading component 114. The e-reading device 110 can execute the service interface 112 to receive resources and data from the network service 120. The service interface 112 can signal, to the network service 120, an identifier for the user and/or user account. The service interface 112 can interface with the network service 120 to receive resources such as applications and content items (e.g., e-books, music files, etc.) from the network service. Optionally, the e-reading device 110 can communicate with multiple services in order to receive resources. The resources that can be received can be responsive to user-input or action (e.g., purchasing input), or automated (e.g., automatic download of new issue of periodical based on user subscription data).

The e-reading device 110 can execute the e-reading component 114 to enable e-reading activities. In one aspect, the e-reading component 114 can render paginated content from e-books (e.g., electronically formatted literary works). The e-reading device 110 can acquire (e.g., purchase, rent or otherwise download) e-books 129 from the network service 120. The e-books 129 can be associated with the account of the user, so the e-reading device 110 may signal account, device or user identification 127 to the network resource in order to obtain or download e-books 129. Many e-books, such as literary works which are primarily text-based (e.g., novels) can be paginated on-the-fly by the e-reading component 114, based on, for example, a display size of the device and/or font size settings of the user or device.

The e-reading device operates to provide an intra-page digital bookmark feature 115 in connection with rendering e-books. The bookmark feature 115 can include an invocation trigger 113 which initiates processes for implementing the bookmark feature. The bookmark feature 115 can also include a pointer 117, which includes a data item that is a link or an association with a particular location of an e-book. The pointer 117 can also be associated with a graphical indicator 119, such as an icon, denoting visually the existence and location of the pointer 119.

The invocation trigger 113 can be provided through a setting or menu feature that the user can operate when using the e-reading device 110. When invoked, the digital bookmark feature 115 can be implemented to have multiple modes of operation and purposeful use, each of which provide a functionality for enabling a type of bookmark positioning and use. In one implementation, e-reading device 110 implements the bookmark feature 115 by inserting a pointer 117 at a desired location in a displayed text window (sometimes termed the “bookmark location”). The insertion of the pointer 117 can be responsive to user input. By way of example, the user input can correspond to the user inserting a graphic indicator 119 of the pointer 117 at a desired location in a displayed text window. In the context of paginated text, the selected location can be provided at a border (e.g., left or right border), or at a location within the border of a paginated text (e.g., between text lines). Still further, the selected location can, by way of proximity or other indication, denote a particular paragraph (e.g., first line of paragraph, last line of paragraph), line, or location within a line.

According to some embodiments, the invocation trigger 113 can be used to provide the graphic indicator 119 of the bookmark pointer 117. The graphic indicator 119 can be generated to receive user input in the form of placement of the graphic indicator at a particular location within a page of an e-book. In one implementation, the user can drag or otherwise position the graphic indicator 119 at a given location of a page, and the placement of the pointer at a desired location results in the generation of position information which can then be correlated to page data, and specifically the proximity, link or association as between the pointer 117 and a particular text item (e.g., text line) of a rendered page.

When the invocation trigger 113 is first initiated, the pointer 117 and the graphic indicator 119 can be generated at an original location (e.g., on a toolbar, or invokable drop-down or pop-up menu) on a user interface display which also displays the e-book content. When a user interacts with the bookmark pointer, components of e-reading device 110 provide further functionality for controlling the bookmark pointer. A user can trigger the e-reading device 110 to position the bookmark pointer 117 at a chosen bookmark location. For example, the user can perform a designated gesture, or otherwise touch a selected location of a displayed page in order to trigger invocation and placement of the bookmark pointer 117. In another example, the user can trigger the bookmark indicator 113 to display the indicator 119 of the bookmark pointer 117, then drag the indicator 119 of the pointer 117 from an original position to a selected position.

In some examples, e-reading device 110 can be operated to implement the bookmark feature 115 in a shift mode. In the shift mode, a position of the pointer 117 can be adjusted relative to the selected text location associated with the bookmark pointer. The adjustment made to the pointer 117 can be responsive to user input. The bookmark feature 115 can include functionality for triggering the e-reading device 110 to repaginate a portion of an e-book around the newly selected text location.

The bookmark indicator 119 of the pointer 117 can include indicia (e.g., an icon) that is initially provided by default at an original location on the display screen. The bookmark indicator 119 can be graphically manipulated with user input, particular as to movement on a page. The movement of the indicator 119 can set the pointer 117 for the bookmark feature 115 to identify an in-page bookmark location (e.g., on the border next to a text line). The bookmark indicator 119 can also be moved again, so as to be relocated in response to user input.

In an example, when bookmark feature 115 is operated in the bookmarking mode, a change in position through manipulation of the bookmark feature 115 can be triggered by a user inserting the bookmark pointer at a selected text location. The bookmark feature 115 can be adjusted from a bookmarking mode to a shift mode in response to the user specifying a designated user input. For example, the user can signify an action that corresponds to a touch input on a display screen of the e-reading device where an icon indicator of the pointer 117 is provided. In certain implementations, the designated user input action corresponds to a touch and hold, which triggers the e-reading device 110 to effectuate the bookmarking mode, shift mode (and related repagination), and/or toggle between modes. More specifically to some embodiments, e-reading device 110 implements the shift mode of bookmark feature 115 in response to the user providing a designated input for moving the bookmarked location upwards or downwards on the display screen. The bookmark feature 115 can include functionality for triggering the e-reading device to adjust the displayed content of the e-book above and below the bookmarked location, so that the bookmarked location is repositioned while the remainder of the e-book is shifted in a manner that maintains the original sequencing of the e-book. Thus, when the bookmarked location is moved between positions on the display, the displayed content above and below the bookmarked location is adjusted and repaginated accordingly.

Hardware Description

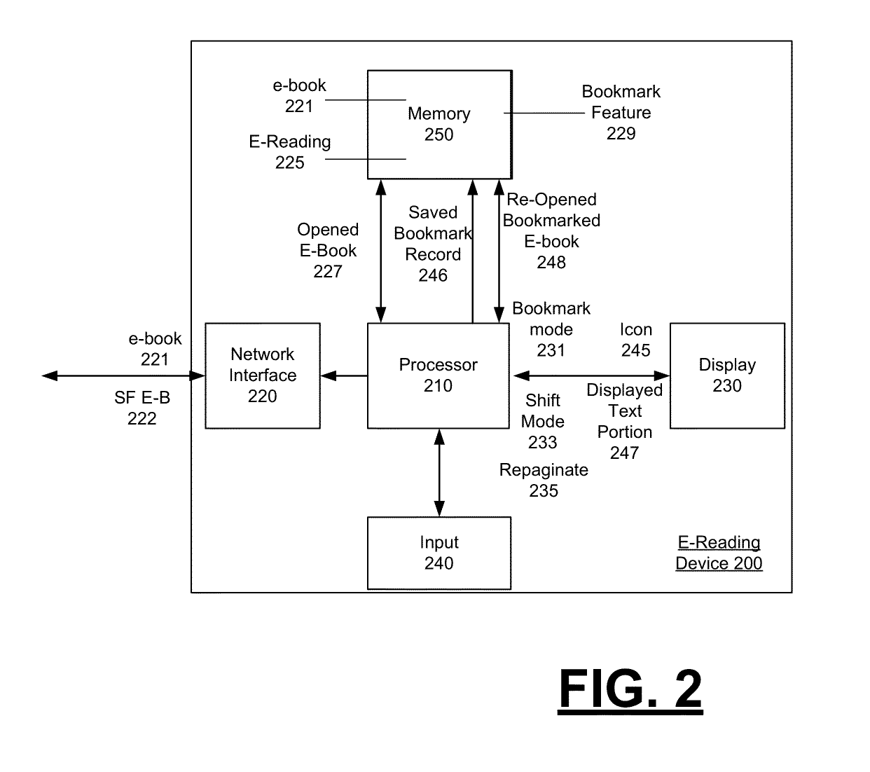

FIG. 2 illustrates an example of an e-reading device for use with one or more embodiments described herein. In an example of FIG. 2, an e-reading device 200 can correspond to, for example, a mobile computing device such as implemented or used by an example of FIG. 1.

With reference to FIG. 2, e-reading device 200 includes a processor 210, a network interface 220, a display 230, one or more input mechanisms 240, and a memory 250. The processor 210 implements functionality described in FIG. 2 using instructions stored in the memory 250. Consequently, while references are made below for how aspects of e-reading device 200 perform various kind of functionality, these references are made for simplicity and correspond to the operation of hardware through the execution of stored instructions by processor 210.

Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 executes instructions to receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reading component 114 in FIG. 1). The memory 250 can also store instructions for implementing a bookmark feature (“bookmark feature instructions 229”). By executing bookmark feature instructions 229, the processor 210 can provide a bookmark pointer 117 and invocation trigger 113, as well as other functionality such as described with a shift mode implementation of a bookmark feature. Responsive to certain user inputs, processor 210 executes e-reading instructions 225 to provide an opened e-book 227 under which portions (e.g. one or more pages), are rendered in a displayed text window generated on the display 230. The processor 210 can access the bookmark feature instructions 229 in order to provide generate bookmark feature having an icon 245 or other graphical feature. The icon 245 can be provided, for example, in a toolbar, option menu, or other setting, so that it can be displayed concurrently with a displayed text portion 247 of the e-book 221 on the display 230. The display 230 can receive a bookmark input (e.g., touch input) at the icon 245 to invoke the bookmark feature 229 and operate under a bookmark mode 231.

Different kinds of input can be received in connection with the processor 210 executing bookmark instructions 229. In one embodiment, a bookmark input can be received through user interaction with the display 230. The bookmark input can be based on a change in position of the icon 245, such as by clicking and dragging or touching and swiping. The change in position of the icon can correspond to movement of the icon from an initial position to a desired location in the displayed text portion 247 on the display 230. Processor 210 can execute to insert icon 245, representing a pointer, at the desired bookmarked location in connection with movement of the icon 245. In another implementation, the icon 245 can be tapped or clicked upon as a first bookmark input, after which another tap or click to select a desired location inserts the bookmark pointer at the selected location. In variations, processor 210 executes the bookmark feature instructions 229 to provide a bookmark pointer in response to the user providing a certain click or tap input (e.g. one or multiple, or for a period of time exceeding a threshold) at a location.

According to variations, the bookmark feature instructions 229 can be executed to provide multiple modes of operation and purposeful use in response to a trigger (e.g., user input). In one implementation, the bookmark feature instructions 229 execute to provide each of a bookmark mode 231 and shift mode 233, as well as a repagination operation 235. In the shift mode 233, the processor 210 responds to user shift inputs to adjust a position of the bookmark pointer at a selected text location to a different bookmarked screen location in the displayed text window of a display. When the repaginate operation 235 is executed, the processor 210 responds to a shift input by repaginating the displayed text around (e.g. above and below) the new selected screen location of the bookmark pointer.

In a further embodiment, the processor 210 can execute the bookmark feature instructions 229 such that bookmark mode 231 and the shift mode 233, as well as the repagination 235, naturally occur in progression. For example after inserting a pointer as described above in the bookmark mode 231, processor 210 executes the bookmark feature instructions 229 to implement the shift mode 233, in which the bookmarked text location is repositioned to the new bookmarked screen location. The repagination 235 may occur automatically upon shifting the bookmarked screen location. According to other embodiments, the processor 210 can change between operating modes based on designated input actions provided by the user. For example, display 230 can be operated to receive a designated user input corresponding to the user providing a particular kind of touch input on the display screen where the bookmark icon 245 is displayed. When the designated input action is detected, a corresponding input is signaled which is associated with one of the bookmark mode 231 or shift mode 233. The processor 210 can toggle implementation of the bookmark feature between modes to be responsive to different inputs at the bookmark icon 245, such as the sequential or varying duration of clicks or taps, or position manipulation of the indicia 245.

According to some variations, under the bookmark mode 231, the shift mode 233 and repagination 235, when the user is about to end a reading session for the opened e-book 227, the user provides input that is indicative of a bookmarked text location and a bookmarked screen location. The inputs are saved as a bookmark record 246 in memory 250 for the opened e-book 227. Upon re-opening, the saved bookmark record 246 is recalled such that a re-opened displayed text portion of the bookmarked e-book 248 is rendered in the displayed text window to include and reflect the bookmarked text location at the bookmarked screen location—and with surrounding text repaginated accordingly on the display.

Device System

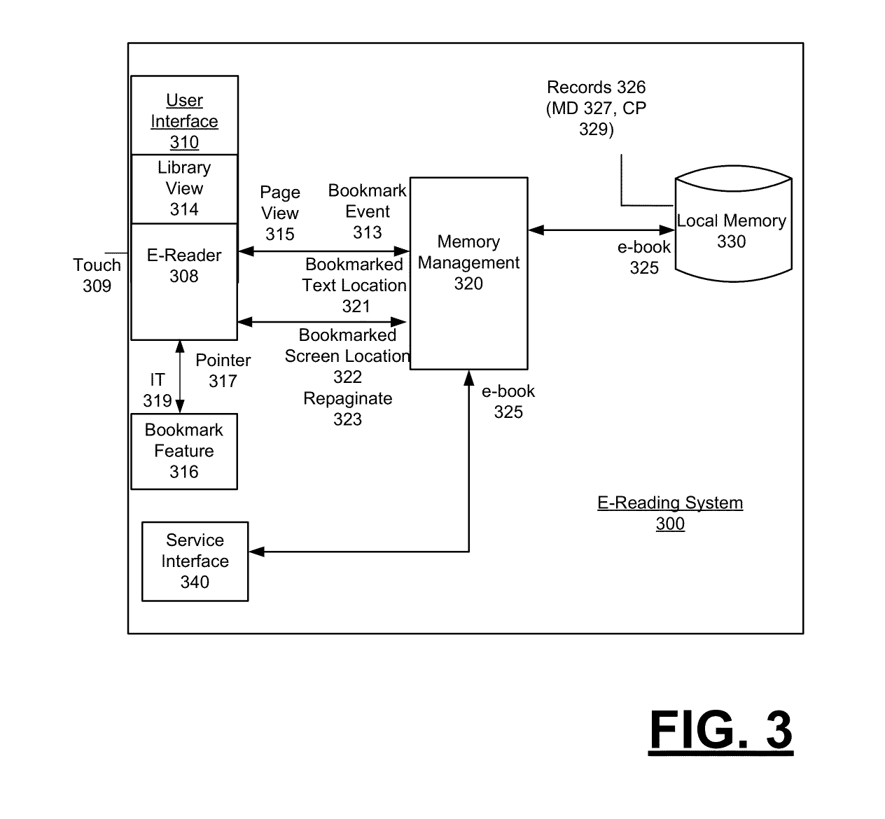

FIG. 3 illustrates an e-reading system in accordance with one or more embodiments. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as stored instructions for an application, which are executed via hardware (e.g., via one or more processors) of an e-reading device such as shown with examples of FIG. 1 or FIG. 2.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels), as well as pagination provided by periodicals (e.g., magazines, comic books, journals, etc.). Many e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of the content 329 for individual e-books for purpose of rendering e-books via the user interface 310. Additionally, the management module 320 can retrieve metadata 327 to render metadata content (e.g., indicators of e-books or lists of e-books) with the user interface 310.

In an example of FIG. 3, the user interface 310 of e-book system 300 includes an e-reading component 308, a library view component 314 and a bookmark feature 316. The e-reading component 308 can include functionality to (i) render page views 315 from a particular e-book, including detecting page transition events (and which may correspond to, for example, a page turn, a chapter turn, or a clustered page turn), and (ii) detect a bookmark event 313. The page views 315 can include the content portion 329 of the e-book being read (e.g., opened or rendered). For example, the e-reading component 308 can display a page view 315 from an e-book corresponding to a novel or periodical, and the page view may include text and/or image content. The bookmark event 313 is invoked by a user while reading a rendered page view 315. The bookmark event 313 (as well as page turn events during a reading session) can be received as touch input 309 through the e-reading component 308. For example, a pointer insertion at the bookmarked text location 321 can be signaled through touch input 300 that is a tap at the desired bookmarked text location (or tap and swipe of an icon feature from an initial position to the bookmarked text location, as elsewhere herein described).

The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books that are provided remotely (e.g., provided on network service 120).

More specifically, in some implementations, the memory management module 320 can be triggered into archiving e-books. In archiving an e-book, the content portion 329 of the e-book can be removed from the local memory 330, while the metadata portion 327 of the record 326 remains stored in the local memory 330. The trigger for archiving e-books can be based on the user input, or generated programmatically in response to events such as memory management processes (e.g., process to archive e-books that have been read; process to detect when free memory is below threshold, etc.). The library view component 314 can display the indicator of the archived e-books using the metadata content 327.

The bookmark feature 316 can be provided as functionality that is integrated with the e-reading component 308. In one implementation, the e-reader 308 provides an input feature for enabling the user to signal the invocation trigger 319 for the bookmark feature 316. In response to the invocation trigger 319, the bookmark feature 316 can generate a bookmark pointer 317. The bookmark pointer 317 can be provided with a graphical indicator (e.g., icon) that can be manipulated in position to mark the location of the bookmark placement. In this way, the bookmark pointer can be linked to corresponding content of a given page view, rendered through the e-reading component 308.

The bookmark feature 316 can include be provided through user-interface features which are responsive to input (e.g., touch input 309). Among other functions, touch input 309 can be used to initiate invocation trigger 319 for the bookmark feature 316, as well as manipulate a position of the bookmark pointer and/or reposition the bookmark pointer. Examples of how touch input 309 can be interpreted with respect to bookmark feature 317 include (i) bookmark inputs (e.g., indicating a mode of operation for inserting a bookmark pointer at a bookmarked text location); and (ii) shift inputs (e.g., shifting the location of the bookmarked text location at a desired bookmarked screen location on the display). Repagination may be automatically deployed upon shifting the bookmarked location, or may be invoked as a further operating mode (e.g., via another corresponding touch input).

In an embodiment, the bookmark feature 316 executes to detect manipulation of the bookmark feature 316 (e.g., touch input 309) while the bookmark feature is provided through the e-reading component 308. The bookmark feature 316 includes logic for interpreting movement of the graphic indicator of the bookmark feature 317. For example, manipulation of the bookmark feature 317 (e.g., a user's touching of the bookmark feature) while in the bookmark mode can be interpreted as a command to position the pointer at the bookmarked location. The same manipulation in the shift mode can be interpreted as a command to reposition the bookmarked location at the desired bookmarked screen location. Accordingly, based on the mode of operation at the time when bookmark feature 316 is invoked, the bookmark feature 316 can provide a signal (e.g., bookmarked text location 321, bookmarked screen location 322, and/or repagination 323) to the memory management module 320. Each of these signals may correspond with values that are stored as respective records, such as position coordinates relative to the e-book text (for the bookmarked location) which are relative to the display screen. Based on such values, when the bookmarked e-book is re-opened, the memory management module 320 retrieves a page view 315 (or page views) from the local memory 326 to appropriately reflect the respective coordinate values for these locations, and for rendering text around the recalled pointer.

Methodology

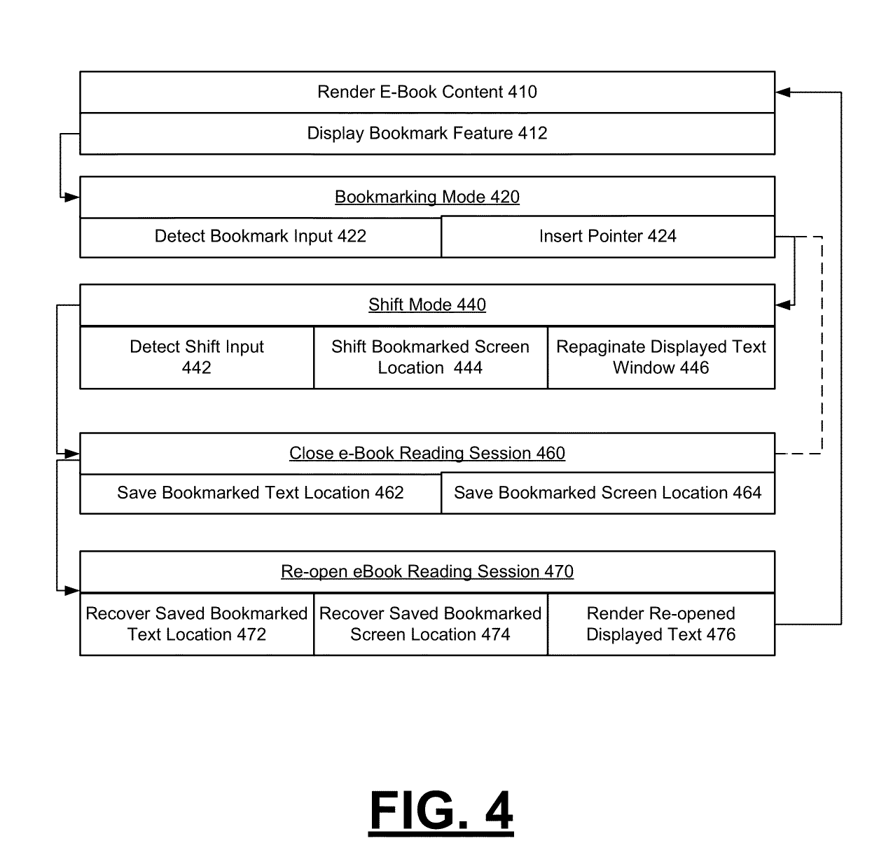

FIG. 4 illustrates a method for implementing a digital bookmark for bookmarking a chosen location along the content of an e-book, according to an embodiment. An example such as described by FIG. 4 can be implemented using components such as described with regards to FIG. 1, FIG. 2, or FIG. 3. For example, stored instructions corresponding to one or more aspects of the method of FIG. 4 may be executed by one or more processors, operating hardware of an e-reading device. Accordingly, reference may be made to elements of other figures for purpose of illustrating suitable elements or components for performing a step or sub-step being described.

With reference to FIG. 4, e-reading device 110 renders e-book content (410). This can include paginated content, and various page transition mechanisms can be utilized to implement page transitions. For example, the user can tap an edge of a display screen of the device to perform a page turn. The e-reading device 110 can also enable a bookmark feature (412) while displaying pages from an e-book. An trigger for invoking the bookmark feature can be displayed concurrently with pages of the e-book. In some embodiments, the bookmark feature is intermittently or selectively provided. For example, a trigger for initiating the bookmark feature can be displayed as part of a menu function provided on a perimeter of the e-reading space and/or the bookmark feature may be invoked from another button as a “pull down” or “pop up” display of the function or toolbar or menu of multiple features and functions.

A bookmark input (422) is detected to invoke the bookmarking mode (420), and to insert a pointer (424) at a desired bookmarked location within the rendered e-book content. For example, with reference to FIG. 3, a bookmark feature 316 executes to receive input indicating a contact movement of the user (e.g. touch and swipe), and correlates the contact movement to the bookmarked text position. In this way, the movement of the bookmark feature corresponds to the user's contact with a touch sensitive display screen of the e-reading device 110, with the user touch coinciding in position to a movable element of a bookmark interface.

After inserting the pointer (424), the bookmark feature can selectively be switched into a shift mode 440. This adjustment may be done manually (e.g., in response to a user selection), or automatically after pointer insertion is completed. In the shift mode, the e-reading device can detect a shift input (442). In response, the bookmarked screen location is shifted from an initial location to a new desired location (e.g., by shifting upwards above or downwards below the initial location on the screen) (444). Upon the shift, the displayed text window, and remainder of the e-book as appropriate, is adjusted and repaginated to properly render the e-book content above and below in the displayed text window (446). The user may then close the e-book reading session (460), and the e-reading device operates to save the bookmarked text location (462), as well as saving the bookmarked screen location (464). Subsequently, the e-book may then be reopened for a new e-book reading session (470). During the new session the e-reading device operates to recover the saved bookmarked text location (472) and also recover the saved bookmarked screen location (474). This recovered bookmark location information is used to render the re-opened displayed text window to correspond with the bookmarked text and screen locations, respectively (476).

### Examples

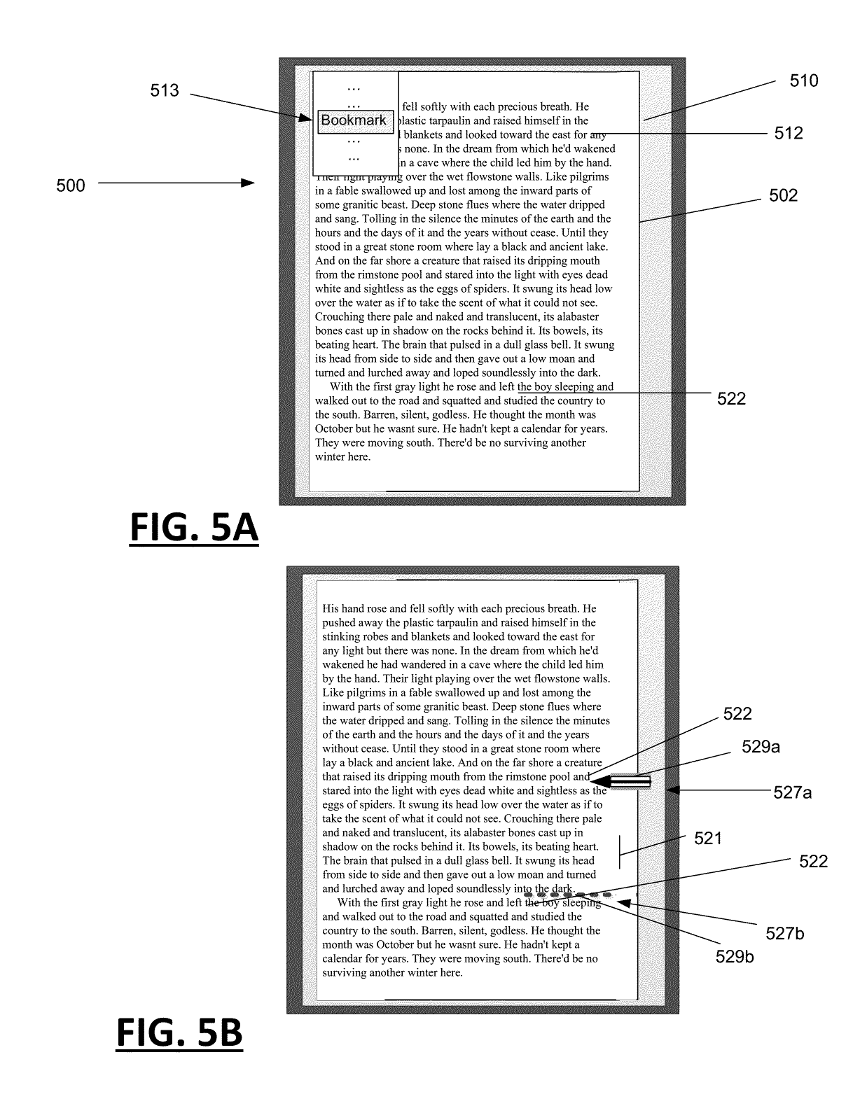

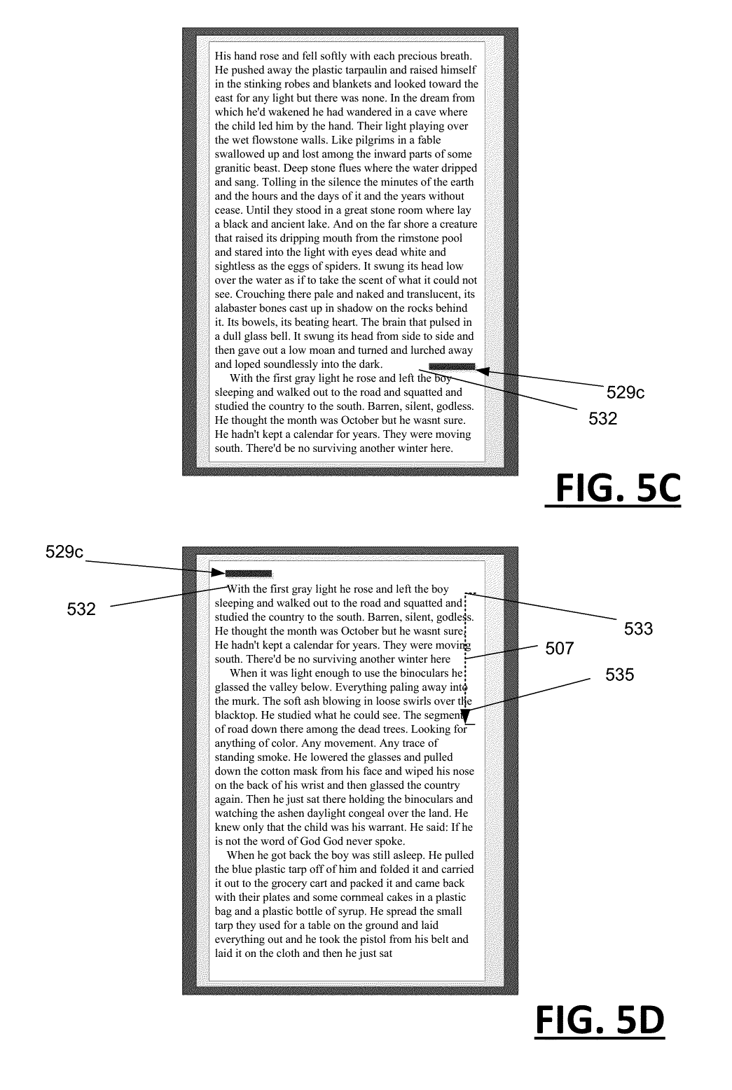

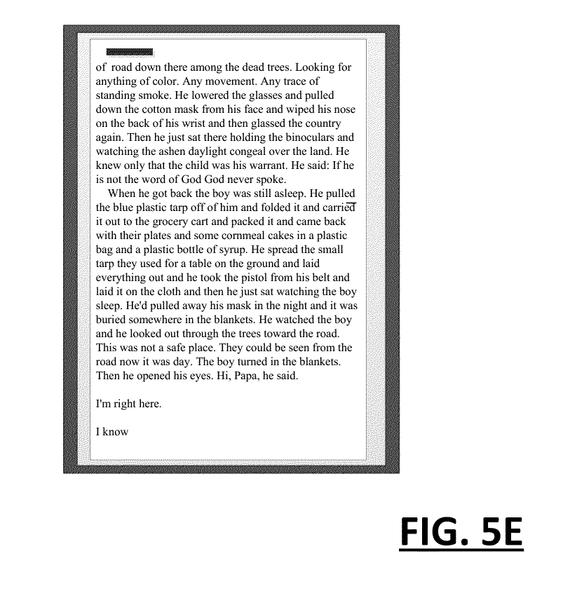

FIG. 5A and FIG. 5B illustrate an example of an e-reading device which implements a digital bookmark feature, according to one or more embodiments. In more detail, an example of FIG. 5A illustrate an e-reading device 500 which provides e-book content 512 on a display screen 510. The e-reading device 500 renders a window 502 on a display surface of the e-reading device 500. The window 502 can render content from a selected e-book (“e-book content 512”). The window 502 can also be rendered with a menu set or other interface for providing the user access to trigger multiple functional features, settings or preferences. Among the functionality, window 502 can be provided with invocation trigger 513 for a bookmark feature 115 (see FIG. 1). The invocation trigger 513 can be provided as, for example, an item of a pull-down menu. When the invocation trigger 513 is selected, the graphic indicator of a bookmark pointer can be displayed and positionally manipulated to set bookmark placement and trigger other functionality.

With further reference to an example of FIG. 5A and FIG. 5B, the invocation trigger 513 can be selected in order for the user to select the bookmark position on the rendered page. FIG. 5B illustrates different implementations of a book mark pointer 527a, 527b with each implementation including an alternative graphic indicators 529a, 529b. In one implementation, bookmark pointer 527a is positioned in the border space 521 of the e-book, and the corresponding graphic indicator indicates a book mark location 532 (end of text line) by way of proximity and directional arrow. In another implementation, the bookmark pointer 527b is positioned within the text, with an alternative graphic indicator 529b. Thus, as shown with examples of FIG. 5A and FIG. 5B, bookmark pointers can be placed adjacent a text line (e.g., in the right border 521, adjacent to a last word or character of a particular line), or between the borders that bind the text content.

In response to a selection of the invocation trigger 513, the e-reading device 500 inserts a bookmark pointer at a user-specified bookmark location 522 within the displayed text content 512, such as to mark the end of a reading session. This may be done by clicking or tapping on the invocation trigger 513, and/or dragging or swiping the graphic indicator 529a, 529b from an origin (e.g., top of page) to the selected bookmarked text location 522.

FIG. 5C shows an example where a reading session is re-opened. After a reading session for a bookmarked e-book is closed and then re-opened for another reading session, the bookmarked location 532 is reflected in the first opened page via the bookmark graphic indicator 529c (shown in another alternative form). While the graphic indicator 529c serves to graphically inform the reader where he/she last read in the prior reading session, the bookmark feature also operates in a shift mode to move the bookmarked location from its initial location 532 shown in FIG. 5C to a shifted bookmarked screen location 532 shown in FIG. 5D.

FIG. 5D also illustrates implementation of a shift mode. In the shift mode, the bookmarked location 532 with the graphic indicator 529c is automatically repositioned to appear as the top of the page. In the repositioning, text surrounding the bookmark location is positioned in prominence at, for example, a top of the page. A remainder of the e-book is repaginated about the bookmarked location 532.

With further reference to an example of FIG. 5D, in one implementation, the graphic indicator 529c can receive a continuous drag input 507, corresponding to a first shift input, in order to drag the bookmarked text location from a first screen location 533 to a second screen location 535. The e-reading device can implement the bookmark feature in order to recognize release of the continuous drag input at the second screen location 535 to shift the bookmarked text location to the bookmarked screen location. With reference to FIG. 5E, the text surrounding the bookmark location 532 can be shifted to reflect the repagination in which the bookmark screen location 535 is transitioned to the top of the page.

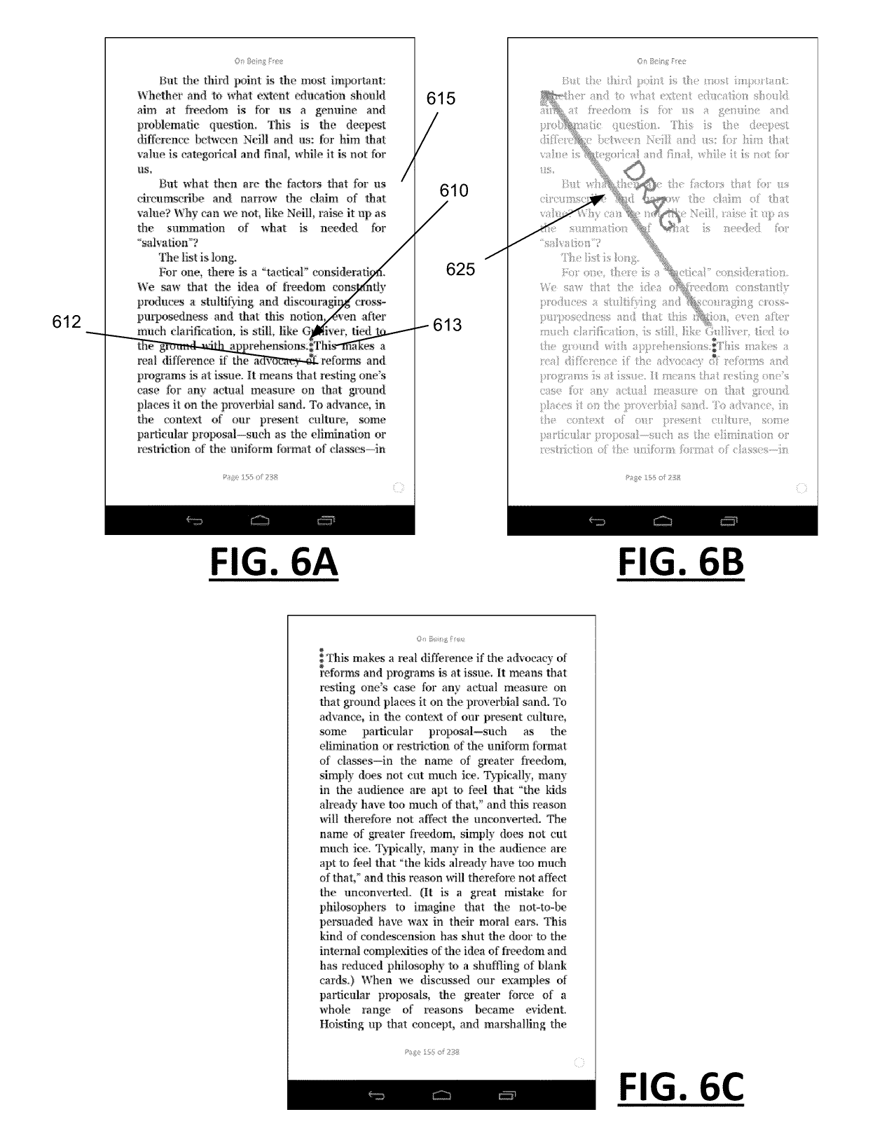

FIG. 6A through FIG. 6C illustrate another implementation of a bookmark feature, in accordance with one or more embodiments. In FIG. 6A, a user can position a pointer 610 with a corresponding graphical indicator 612 (e.g., 4 dots) within the body of the text, so as to signal, for example, an end of sentence. In one implementation, the user can move the indicator 612 to any location on the page, such as at a border 615, next to a specific word and/or at a bottom of a paragraph. Once the graphic indicator is set, the pointer 610 is associated with the text or location on the specific page. In one example, the e-book can be closed, and then opened in order for the user to return to the page of the pointer 610.

Furthermore, as shown by an example of FIG. 6B, once the pointer 610 is set, the text 613 (or other portion of the page view) associated with the pointer can be repositioned prominently, such as at the top of page. The repositioning of the text can be done automatically, or as shown with an example of FIG. 6B, in response to user input. In particular, the user can perform a designated action, such as a long drag 625 (which is an example of touch input) from the original position of the indicator 612 to a relative new location of the page (e.g., top corner), as specified by the input. The remainder of the e-book can be repaginated to accommodate the text 613 appearing at the beginning of the page (or at another prominent location within the page). In this way, the user can provide input to trigger repagination, and further manually select the new position of the text item which is identified by the bookmark pointer 610.

FIG. 6C illustrates that the graphic indicator 612 of the pointer 610 when positioned at the relative new location of a rendered page. As shown with FIG. 6C, when the pointer 610 is repositioned, a remainder of the e-book can be repaginated to accommodate the movement of the text or page portion associated with the repositioned indicator 612.

It is further appreciated, however, that a shift mode of operation may be executed in response to a trigger which does not utilize user inputs, to render the re-opened text with the bookmarked screen location at the top of the page. For example, an e-reading device may provide a default re-opened configuration after bookmarking a place on the page. Moreover, user inputs may direct a downward shift to the bookmarked screen location, either from the top screen position after a re-opening, or during the initial bookmarking activity—with repagination performed appropriately around the resulting bookmarked screen location.

It is to be appreciated that the various aspects of this disclosure, as illustrated by the various detailed embodiments described, provide a computing device that is operable via a processor and user interface to transform an e-book into a bookmarked e-book with the exact place a reader last ended a reading session, such as at a word, line, or paragraph, within a rendered page of a displayed text window of an e-reading device. Moreover, certain embodiments also further transform an e-book into a re-paginated, bookmarked e-book, rendering with the bookmarked text location re-positioned to desired screen location, such as at the top of the rendered re-opened page, or such as to allow a portion of a prior page to be shown above the bookmarked screen location without requiring the reader to turn back to the prior page.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device, comprising:
a memory resource to store a set of instructions and an e-book, the e-book including a plurality of predetermined chapter designations;
one or more processors that access the memory resource to:
render at least a portion of an e-book, including displaying individual pages of text of the e-book, in a displayed text window of a display;
while displaying one or more pages of the e-book, implement a bookmark feature that is operable in a bookmarking mode in which, in response to a bookmarking input from a user, inserts a pointer at a bookmarked text location along the displayed text;
upon a closing of the e-book, save a record of the bookmarked text location corresponding with the e-book;
upon a re-opening of the e-book after the closing, recover the record for the bookmarked text location and render a re-opened displayed text portion of the e-book that includes and reflects the bookmarked text location in the displayed text window.

2. The computing device of claim 1, wherein the processor is further operable to:
render a bookmark graphic corresponding with the bookmark feature as a graphical element on the display.

3. The computing device of claim 2, wherein the processor is further operable to:
render the bookmark graphic at the bookmarked text location.

4. The computing device of claim 2, wherein the processor is further operable to:
render a bookmark icon at a toolbar location on the display;
allow the user to invoke the bookmark feature by providing a first bookmark input at the bookmark icon; and
allow the user to insert the bookmark at the bookmarked text location via a second bookmark input at the bookmarked text location.

5. The computing device of claim 4, wherein the processor is further operable to:
receive a continuous drag input from the first bookmark input to drag the bookmark icon from the toolbar location to the bookmarked text location; and
release the continuous drag input at the bookmarked text location as the second bookmark input to thereby insert the pointer at the bookmarked text location.

6. The computing device of claim 4, wherein the processor is further operable to:
provide the first and second bookmark inputs as distinct respective inputs at the toolbar location and bookmarked text location, respectively.

7. The computing device of claim 1, wherein:
the displayed text window comprises a top and a bottom to correspond with earlier and later occurring portions, respectively, of the e-book text; and
the processor is further operable to, upon the re-opening of the e-book, render the re-opened displayed text portion starting with the bookmarked text location positioned at the top.

8. The computing device of claim 1, wherein:
after the pointer is inserted at the bookmarking text location, the bookmark feature is adjustable to a shift mode;
in response to a shift input by the user in the shift mode, the bookmarked text location is movable to a bookmarked screen location in the displayed text window; and
the re-opened displayed text portion is adjusted by the processor around the bookmarked text location at the bookmarked screen position within the displayed text window.

9. The computing device of claim 8, wherein the processor is further operable to:
render a bookmark graphic corresponding with the bookmark feature as a graphical element on the display;
adjust the bookmark feature from the bookmarking mode to the shift mode in response to a first shift input from the user at the bookmark graphic; and
in the shift mode, shift the bookmarked text location to the bookmarked screen location in response to a second shift input from the user.

10. The computing device of claim 9, wherein the first shift input comprises a sustained input at the bookmark graphic for a duration of time that exceeds a threshold.

11. The computing device of claim 9, wherein the processor is further operable to:
receive a continuous drag input from the first shift input to drag the bookmarked text location from a first screen location to a second screen location; and
recognize a release of the continuous drag input at the second screen location as the second shift input to thereby shift the bookmarked text location to the bookmarked screen location.

12. The computing device of claim 1, wherein:
the e-book is paginated with multiple designated pages along the progression for display within the displayed text window; and
the processor is further operable to repaginate the e-book to reflect the re-opened displayed text portion as a page.

13. The computing device of claim 1, wherein:
the e-book is organized with words, lines, paragraphs, and pages, respectively along a progression; and
the bookmarked text location corresponds with a word, line, or paragraph on a rendered page.

14. The computing device of claim 1, further comprising:
a mobile computing device with a touch screen display providing a user input interface via touch inputs to the display.

15. A method for operating a computing device, the method being implemented by one or more processors and comprising:
rendering at least a portion of an e-book, including displaying individual pages of the e-book in a displayed text window of a display;
while displaying one or more pages of the e-book, implementing a bookmark feature that is operable in a bookmarking mode;
in response to a bookmarking input from a user in the bookmarking mode, inserting a pointer at a bookmarked text location within the displayed text window;
after inserting the bookmark and upon a closing the e-book, saving a record of the bookmarked text location corresponding with the e-book; and
upon a re-opening of the e-book, recovering the record for the bookmarked text location and rendering a re-opened displayed text portion that includes and reflects the bookmarked text location in the displayed text window.

16. The method of claim 15, further comprising:
rendering a bookmark graphic corresponding with the bookmark feature as a graphical element on the display.

17. The method of claim 16, further comprising:
rendering the bookmark graphic at the bookmarked text location.

18. The method of claim 15, further comprising:
upon the re-opening of the e-book, rendering the re-opened displayed text portion starting with the bookmarked text location positioned at the top of the displayed text window.

19. The method of claim 15, further comprising:
after the pointer is inserted at the bookmarking text location, adjusting the bookmark feature to a shift mode;
in response to a shift input by the user in the shift mode, moving the bookmarked text location from a first screen location a bookmarked screen location within the displayed text window; and
adjusting the re-opened displayed text portion around the bookmarked text location at the bookmarked screen position within the displayed text window.

20. The method of claim 15, wherein the e-book comprises a progression of text and is paginated with multiple designated pages for display along the progression within the displayed text window, and further comprising:
re-paginating the e-book to reflect the re-opened displayed text portion as a page rendered on the display.
